(19) United States
(12) Patent Application Publication
(10) Pub. No.: US 2024/0405477 A1
(43) Pub. Date: Dec. 5, 2024

(54) SYSTEMS AND METHODS FOR ALIGNING A CONNECTOR INSERT

(71) Applicants: DENSO International America, Inc., Southfield, MI (US); DENSO CORPORATION, Kariya (JP)

(72) Inventor: Peter Atencio, Livonia, MI (US)

(21) Appl. No.: 18/501,598

(22) Filed: Nov. 3, 2023

Related U.S. Application Data
(60) Provisional application No. 63/505,447, filed on Jun. 1, 2023.

(51) Int. Cl. H01R 13/629; H01R 13/518; H01R 43/20

(52) U.S. Cl. CPC H01R 13/629; H01R 13/518; H01R 43/20; H01R 12/716

(57) ABSTRACT

Systems, methods, and other embodiments described herein relate to aligning a connector insert, including electrical pins, relative to a bay that receives a wire harness. In one embodiment, an electronic system includes a connector insert that includes a set of electrical pins extending through a substrate and an insert alignment structure. The electronic system also includes a housing that includes a bay to receive a wire harness, a slot within the bay to receive the connector insert, and a housing alignment structure adjacent to the slot. The housing alignment structure interfaces with the insert alignment structure to secure the connector insert and presses centrally against the connector insert to align the set of electrical pins to the bay.

### CROSS-REFERENCE TO RELATED APPLICATIONS

This application claims benefit of U.S. Provisional Application No. 63/505,447, filed on, Jun. 1, 2023, which is herein incorporated by reference in its entirety.

### TECHNICAL FIELD

The present disclosure relates to aligning a connector insert, including electrical pins, relative to a bay in a housing that receives a wire harness.

### BACKGROUND

Vehicles, as well as many other systems, rely on computers or electronic modules to execute a variety of system operations. Through these electronic modules, data may be received from components of the system and/or data may be transmitted to the components of the system. For example, vehicles include electronic modules that control propulsion systems, brake systems, steering systems, throttle systems, transmission systems, signaling systems, and navigation systems, among other vehicle systems.

In general, electronic modules include electrical connectors, which couple electrical wire harnesses of a controlled component to processors, memory, and other electronic components on a printed circuit board (PCB). A connector may include electrical pins that extend through a substrate of the connector. Electrical pins on one surface interface with the wire harness, while electrical pins on the opposite surface are operatively coupled to electronic components (e.g., processors, memory, etc.) of the electronic module.

### SUMMARY

In one embodiment, example systems and methods relate to a manner of improving the alignment of a connector insert, which includes electrical pins, relative to a bay that receives a wire harness. The electronic system includes a connector insert that includes 1) a set of electrical pins extending through a substrate and 2) an insert alignment structure. The electronic system also includes a housing that includes 1) a bay to receive a wire harness, 2) a slot within the bay to receive the connector insert, and 3) a housing alignment structure adjacent to the slot. The housing alignment structure interfaces with the insert alignment structure to secure the connector insert and presses centrally against the connector insert to align the set of electrical pins to the bay.

In an example, the housing alignment structure and the insert alignment structure center the connector insert within the slot. As a specific example, the housing alignment structure and the insert alignment structure align the connector insert within the slot in two orthogonal directions in a two-dimensional plane.

In an example, the insert alignment structure includes a set of compliant retainer clips that protrude from a surface of the substrate through which the set of electrical pins extends. In this example, the housing alignment structure includes a set of accepting holes that correspond to and receive the set of compliant retainer clips. In a specific example, the set of compliant retainer clips includes 1) a first pair of compliant retainer clips disposed on opposite sides of the surface and 2) a second pair of compliant retainer clips orthogonal to the first pair and disposed on opposite sides of the surface. The connector insert of the electronic system may include a first insert datum defined by a centerline between the first pair of compliant retainer clips and a second insert datum defined by a centerline between the second pair of compliant retainer clips. The bay may include a first bay datum defined by a centerline between accepting holes associated with the first pair of compliant retainer clips and a second bay datum defined by a centerline between accepting holes associated with the second pair of compliant retainer clips. In this example, the compliant retainer clips and the accepting holes align the first insert datum with the first bay datum in the first direction and the second insert datum with the second bay datum in the second direction. In an example, the compliant retainer clips protrude from a surface of the substrate that faces the surface of the housing from which the bay extends.

In an example, the housing alignment structure includes a set of compliant retainer clips having an arm extending from an interior sidewall of the bay and a compliant arm extending parallel to the interior sidewall. The insert alignment structure includes a set of accepting holes that correspond to and receive the set of compliant retainer clips.

In another example, the insert alignment structure includes a first set of datum pads extending from the first sidewall of the substrate and the housing alignment structure includes a first spring on the interior surface of the slot. The first spring applies a force to at least a second sidewall of the substrate opposite the first sidewall. In a specific example, the insert alignment structure includes a second set of datum pads extending from a third sidewall of the substrate that is adjacent and orthogonal to the first sidewall. In this specific example, the housing alignment structure includes a second spring on the interior surface of the slot. The second spring applies a force to at least a fourth sidewall of the substrate opposite the third sidewall. In an example, the slot further comprises a set of datum grooves corresponding to the datum pads, the set of datum grooves and datum pads position the connector insert in the slot.

The present specification also describes an electronic system that includes the connector insert that includes the set of electrical pins extending through the substrate and the housing that includes 1) the bay to receive the wire harness and 2) the slot within the bay to receive the connector insert. The electronic system also includes a connection system that includes 2) the insert alignment structure extending from the surface of the substrate and 2) the housing alignment structure adjacent to the slot that interfaces with the insert alignment structure to secure the connector insert and press centrally against the connector insert to align the set of electrical pins to the bay.

In an example, the housing alignment structure and the insert alignment structure align the first insert datum with the first bay datum in the first direction and the second insert datum with the second bay datum in the second direction.

In an example, the insert alignment structure includes 1) the first pair of compliant retainer clips disposed on opposite sides of the surface of the substrate through which the set of electrical pins extends and 2) the second pair of compliant retainer clips orthogonal to the first pair and disposed on opposite sides of the surface. In this example, the housing alignment structure includes the set of accepting holes that correspond to and receive the set of compliant retainer clips.

In another example, the insert alignment structure includes 1) the first set of datum pads extending from the first sidewall of the substrate and 2) the second set of datum pads extending from the third sidewall of the substrate. The third sidewall is adjacent and orthogonal to the first sidewall. The housing alignment structure includes 1) the first spring on an interior surface of the slot, the first spring applies a force against at least the second sidewall of the substrate that is opposite the first sidewall, and 2) the second spring on the interior surface of the slot. The second spring applies a force against at least the fourth sidewall of the substrate opposite the third sidewall.

The present specification also describes a method. The method includes providing the housing that includes the bay to receive the wire harness and the slot within the bay to receive the connector insert. The method also includes providing the connector insert that includes the set of electrical pins extending through opposite surfaces of the substrate. The method also includes securing the connector insert within the slot via the insert alignment structure and the housing alignment structure. The housing alignment structure centrally pressing against the connector insert to align the set of electrical pins to the bay.

In an example, securing the connector insert within the slot via the insert alignment structure and the housing alignment structure includes 1) aligning the first insert datum with the bay datum in the first direction and 2) aligning the second insert datum with the second bay datum in the second direction.

In an example, the insert alignment structure includes the set of compliant retainer clips protruding from at least one of the opposite surfaces and the housing alignment structure includes the set of accepting holes that receive the set of compliant retainer clips. In this example, securing the connector insert within the slot includes snapping the compliant retainer clips into respective accepting holes.

In an example, the insert alignment structure includes the first set of datum pads extending from the first sidewall of the substrate, and the housing alignment structure includes the first spring on an interior surface of the slot. In this example, securing the connector insert within the slot includes exerting, via the first spring, a force against the second sidewall of the substrate that is opposite the first sidewall to align the set of electrical pins to the bay.

In an example, the method further includes inserting the connector insert through an opposite surface of the housing from which the bay extends.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIGS. 1A and 1B illustrate an assembled view of an electronic system with an aligned connector insert and housing.

FIGS. 2A and 2B illustrate an exploded view of an electronic system with an aligned connector insert and housing.

FIG. 3 illustrates an isometric view of a connector insert to be joined to the housing.

FIGS. 4A-4C illustrate planar views of a connector insert and bay of an example electronic system.

FIGS. 5A and 5B illustrate a cross-sectional view of the connector insert and bay of an example electronic system.

FIG. 6 illustrates an exploded view of an electronic system with an aligned connector insert and housing.

FIGS. 7A-7C illustrate planar views of the connector insert and bay of an example electronic system.

FIG. 8 illustrates a flowchart for one embodiment of a method that is associated with forming an electronic system with a connector insert and a housing.

### DETAILED DESCRIPTION

Systems, methods, and other embodiments associated with improving the alignment of an electrical connector within a wire harness bay are disclosed herein. As previously described, vehicles and other systems use electronic computers or electronic modules to manage the operation of various components of the vehicle or other systems. A “module,” as used herein, includes a computer or electrical hardware component(s), firmware, a non-transitory computer-readable medium that stores instructions, and/or combinations of these components configured to perform a function(s) or an action(s), and/or to cause a function or action from another logic, method, and/or system. A module may include a microprocessor controlled by an algorithm, a discrete logic (e.g., ASIC), an analog circuit, a digital circuit, a programmed logic device, a memory device including instructions that when executed perform an algorithm, and so on. A module, in one or more embodiments, includes one or more CMOS gates, combinations of gates, or other circuit components.

Additionally, module, as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing a particular function.

Electronic modules are used in a variety of products. Given the proliferation of electronic-based systems in vehicles and other systems, the use of electronic modules will likely continue to rise. It may be the case that a single electronic module includes multiple electrical connectors that link different wire harnesses to respective electrical hardware components. Such modules may include a housing, which is a plastic or other material panel, through which a connector is disposed. Behind the housing is a printed circuit board (PCB) or other substrate on which the hardware components are formed. A connector protrudes through the housing to allow an electrical connection of the wire harness to the PCB behind the housing. In these systems, it may be desirable to separate the PCB environment from the wire harness environment. For example, it may be desirable to seal the connectors so that debris, water, or other contaminants do not come into contact with the PCB and other electrical hardware components of the electronic module.

Moreover, it is generally desirable to align the electrical pins of the connector within the bay that receives the wire harness. If the electrical pins are not aligned within the bay, inserting a wire harness into the bay and connecting the wire harness with the electrical pins may be difficult. Misalignment could damage components of the wiring harness and/or connector pins of the connector. In some cases, misalignment may result in a failure to establish an electrical connection and thereby frustrate the purpose of the electronic module. It may be difficult to align a multi-connector PCB to a multi-bay housing so that each set of electrical pins (corresponding to different connectors) is aligned with a respective bay. This is due to the coupled movement of the sets of electrical pins. For example, aligning one set of pins within a respective bay may misalign another set of pins mounted to the same PCB with respect to a respective bay.

Accordingly, the electronic system of the present specification describes a two-piece system for aligning electrical pins within a bay while providing a seal to prevent water, dust, or other contaminants from potentially contaminating the PCB and associated electrical hardware elements. The first component, the housing, is a plastic or other material substrate with a slot. The second component is a connector insert with a substrate and electrical pins that establish the electrical connection. The components are separate but are joined together via alignment structures.

As such, rather than aligning a PCB with multiple sets of electrical pins (each to be mated with a different wire harness) to a housing with multiple bays, the present system aligns individual sets of electrical pins within a respective bay. As such, because each connector insert is individually aligned to a respective bay rather than co-aligned or simultaneously aligned with other connectors on a rigid substrate, the present system results in a reduced tolerance stack-up as compared to what may arise when multiple sets of electrical pins are formed on a single PCB and simultaneously inserted into a housing with multiple respective connectors.

In one particular example, a connector insert includes four compliant retainer clips on opposing sides, and the housing includes respective accepting holes. Via the compliant retainer clips and accepting holes, the connector insert is snapped into the bay of the housing. In another example, the housing includes a spring on one interior sidewall of the slot that receives a connector insert, and the connector insert has datum pads. The spring presses against the connector insert, and the datum pads come into contact with the housing when inserted into the bay.

In this way, the disclosed systems, methods, and other embodiments improve electrical connector alignment by aligning individual connector inserts for individual wire harnesses into individual wire harness bays. The datums of the respective elements are lined up using the respective alignment structures of the connector insert and the bay. As an example, the connector insert is aligned within the bay in an x-direction and a y-direction with respect to the two-dimensional plane of the housing. As such, by aligning the connector insert relative to the bay, the present system ensures that the x- and y-planes of the functional components (e.g., the electrical pins) of the connector insert are correctly aligned with the bay to ensure a correct and precise connection between the pins and a wire harness.

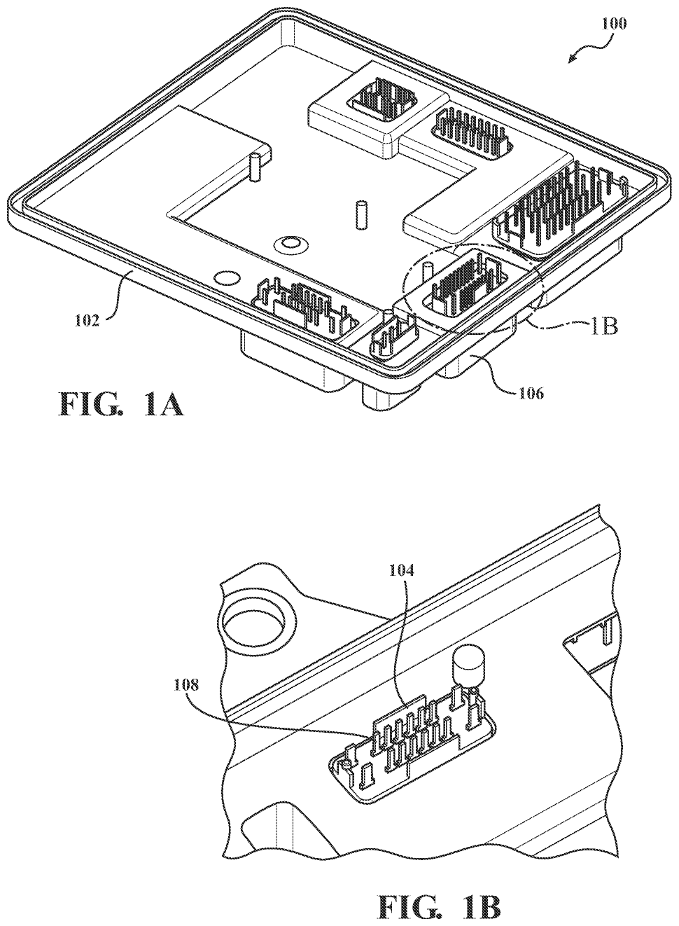

Turning now to the figures, FIGS. 1A and 1B illustrate an assembled view of an electronic system 100 with an aligned connector insert 104 and housing 102. It will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements.

As described above, the electronic system 100 includes multiple components. First, the electronic system 100 includes a housing 102. The housing 102 may be made of rigid materials such as plastic or others. While not depicted in FIGS. 1A and 1B, a PCB with various electrical circuit components may be positioned behind the housing 102. As described above, protecting the electrical circuit components on the PCB from contaminants such as water, dust, or other debris in the wire harness environment may be desirable. As such, the housing 102 may be a barrier between an environment where a wire harness is attached and the electronic module.

The housing 102 includes a bay 106 or a shroud. The bay 106 provides mechanical protection for the portion of the electrical pins 108 that mate with the wire harness. The bay 106 also serves as a guide for inserting the wire harness to ensure correct and precise alignment of the wire harness electrical connection components with those of the connector insert 104. In some examples, the bay 106 may include retention features that lock the wire harness in place. The bay 106 may extend from one surface of the housing 102 and be integrated with and formed of the same material as the housing 102.

As described above and as depicted in FIGS. 1A and 1B, the housing 102 may accommodate multiple connector inserts 104 and bays 106. For simplicity, a single instance of a connector insert 104 is indicated with a reference number. Also, as depicted in FIGS. 1A and 1B and described above, each connector insert 104 is separate and not coupled to a single rigid substrate such as a PCB. Were each connector insert 104 coupled to a single rigid substrate, it may be prohibitively difficult to align each set of electrical pins to the respective bay 106, given the tolerance stack up of aligning multiple sets of electrical pins to respective bays 106.

Also as described above, the electronic system 100 includes a connector insert 104, which facilitates the connection between a wire harness and an electronic module, which may be formed on a PCB and disposed behind the housing 102. The connector insert 104 includes a set of electrical pins 108 that extend through a substrate, which substrate may be formed of a variety of materials, including plastic. In one particular example, the sets of pins 108 provide wire harness mating terminals on one side and PCB mating terminals on the other.

As described below and depicted in the following figures, each of the housing 102 and the connector insert 104 include alignment structures to facilitate the alignment of a connector insert 104 with a respective bay 106. That is, each connector insert 104 may be individually and precisely aligned to a respective bay 106 rather than being aligned to the housing 102. Aligning the sets of electrical pins 108 generally to a housing rather than a particular bay may result in the incorrect alignment of the electrical pins 108 to a respective bay 106. As such, the present electronic system 100 aligns each set of electrical pins 108 based on a functional usage of the connector by aligning the x- and y-position of the electrical pins 108 relative to the x- and y-position of the bay 106 into which they are inserted.

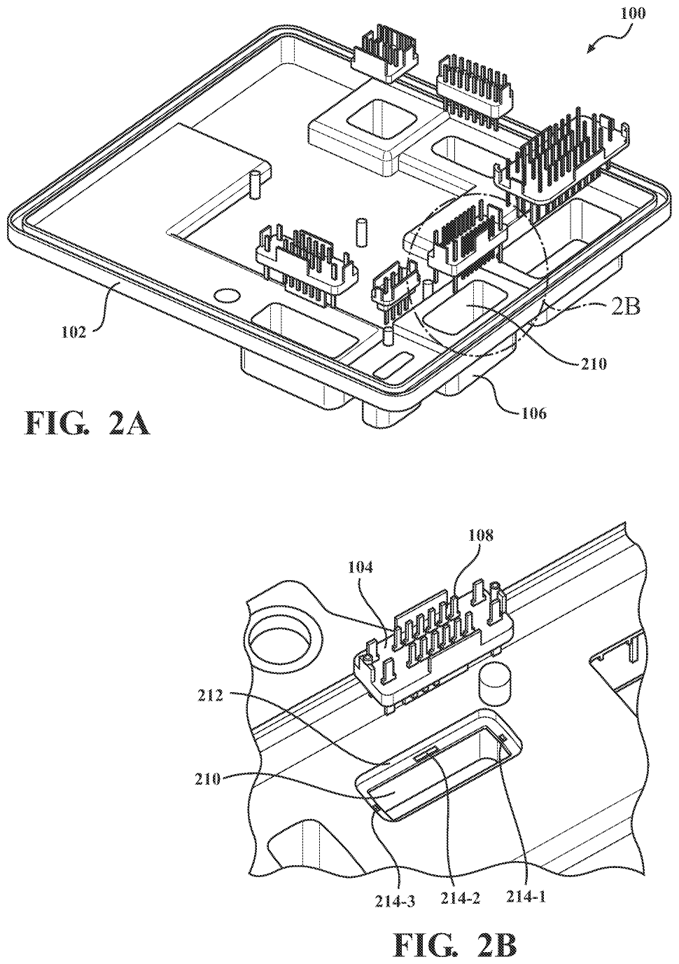

FIGS. 2A and 2B illustrate an exploded view of an electronic system 100 with an aligned connector insert 104 and housing 102. As described above, the housing 102 includes a slot 210 to receive the connector insert 104. The slot 210 is positioned in the housing 102 within the bay 106 such that the electrical pins 108 on the connector insert 104 are disposed within the walls of the bay 106.

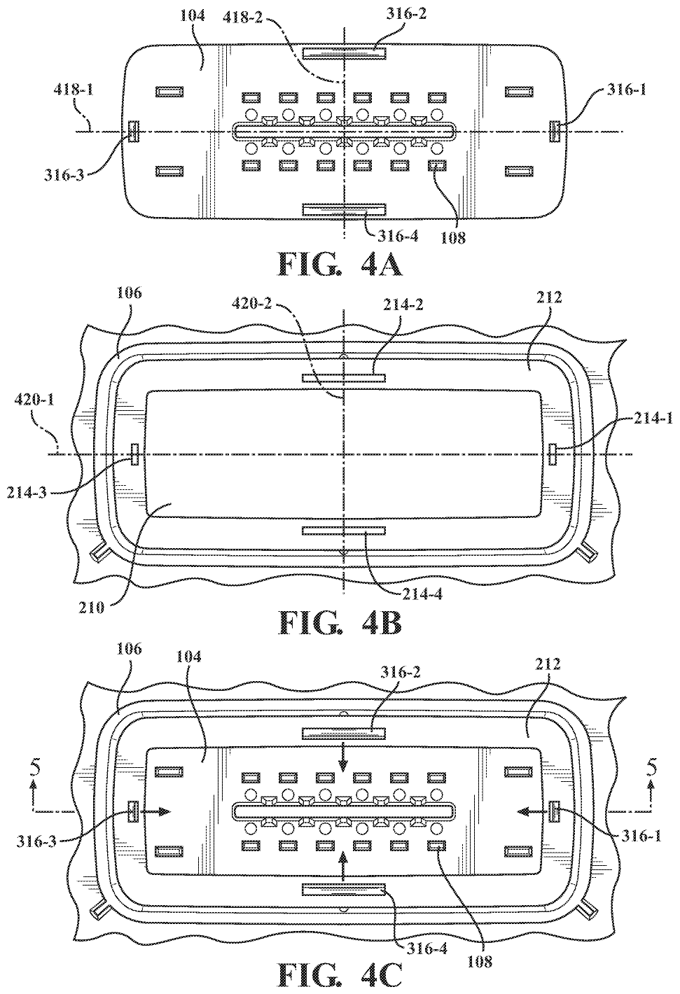

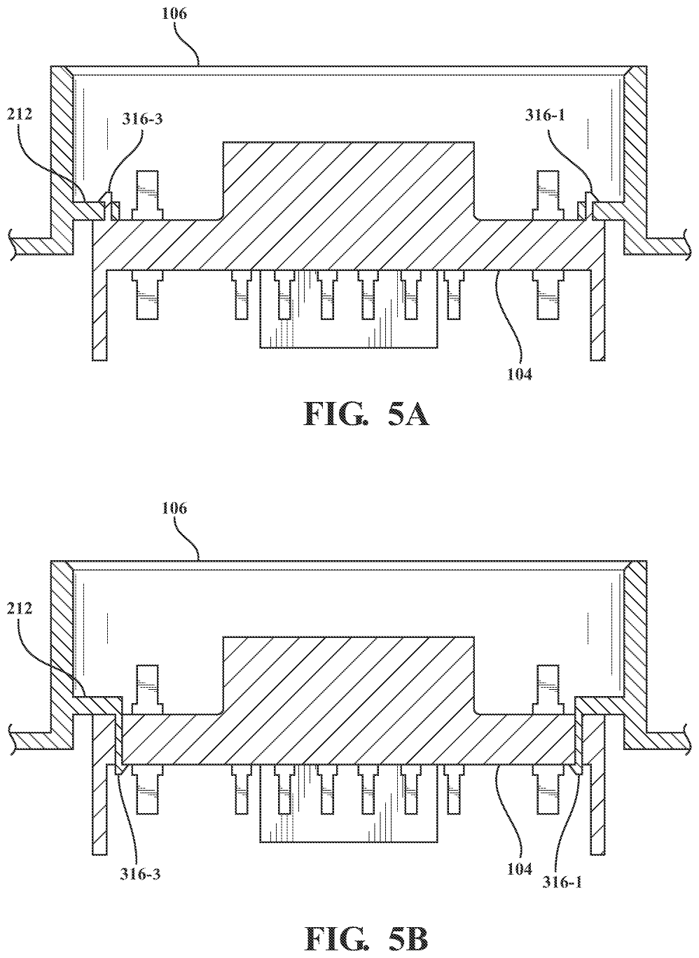

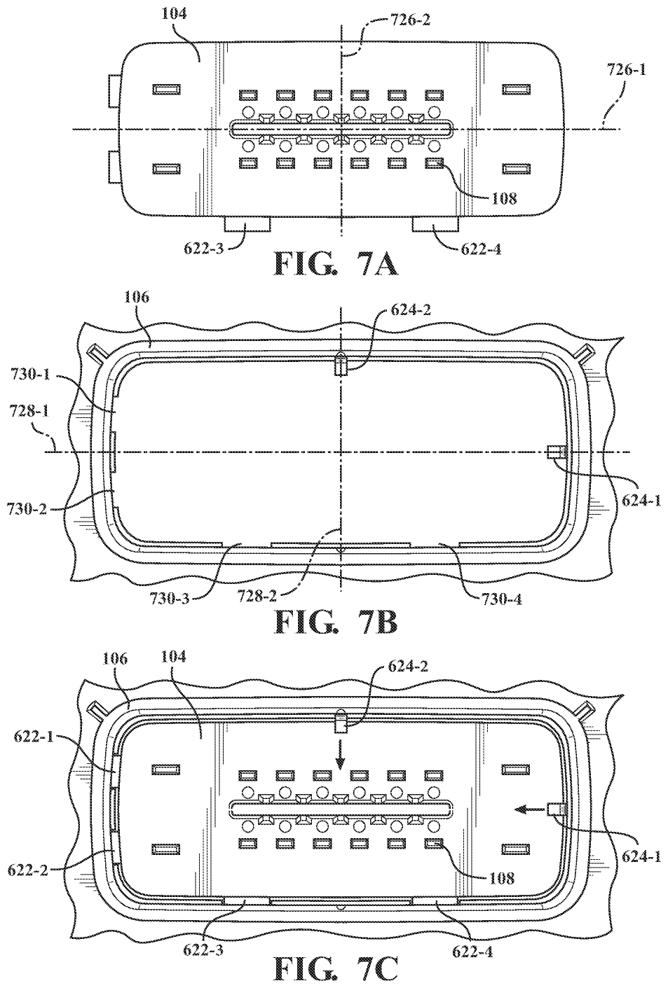

As described above, each of the connector inserts 104 and the housing 102 include alignment structures. The alignment structures may take a variety of forms. In one example depicted in FIGS. 2A-5A, the insert alignment structure of the connector insert 104 includes compliant retainer clips, and the housing alignment structure of the housing 102 includes accepting holes 214-1, 214-2, and 214-3 that correspond to and receive the set of compliant retainer clips. In the example depicted in FIG. 5B, the compliant retainer clips are formed on the housing 102 while the accepting holes are formed on the connector insert. As depicted in FIGS. 2A-5A, the housing alignment structure (e.g., the accepting holes 214-1, 214-2, and 214-3) in the housing 102 are adjacent to the slot 210 and receive the compliant retainer clips to secure the connector insert 104 within the slot 210 and bay 106. As depicted in FIGS. 4A-4C and 7A-7C, the housing alignment structure presses centrally against the connector insert 104 to align the set of electrical pins 108 to the bay 106. That is, the connection system that includes the housing alignment structure and the insert alignment structure aligns the connector insert 104 within the slot 210 in two orthogonal directions in a two-dimensional plane (e.g., an x- and y-direction in an x-y plane). In this example, the slot 210 may include an additional feature to align the connector insert 104 in a z-direction. For example, the slot 210 may include a shelf 212 against which the connector insert 104 sits. During insertion, the connector insert 104 is inserted through the slot 210 from the surface of the housing 102 opposite the surface of the housing 102 from which the bay 106 extends. Through the perspective of FIG. 2, the bay 106 extends from a downward surface of the housing 102, while the connector insert 104 is inserted through an upward surface of the housing 102.

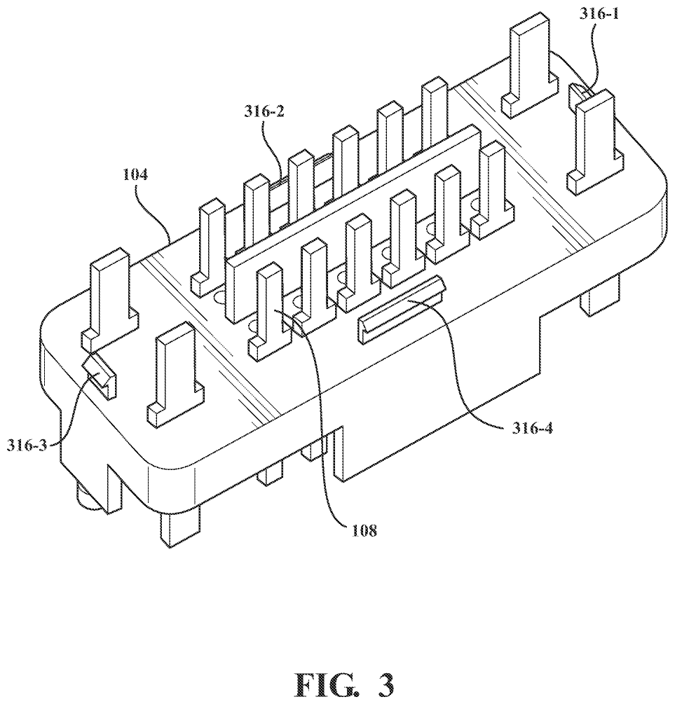

FIG. 3 illustrates an isometric view of a connector insert 104 to be joined to the housing 102. Specifically, FIG. 3 depicts a view of the portion of the connector insert 104 that is disposed within the bay 106 to receive the electrical wire harness. FIG. 3 also depicts a particular example of an insert alignment structure. In this example, the insert alignment structure includes a set of compliant retainer clips 316-1, 316-2, 316-3, and 316-4. The compliant retainer clips 316 protrude from a surface of the substrate through which the set of electrical pins 108 extend. In one example, the compliant retainer clips 316 extend from a surface of the substrate that faces the surface of the housing 102 from which the bay 106 extends.

The compliant retainer clips 316 interact with respective accepting holes 214 to secure the connector insert 104. As depicted in FIG. 3, the compliant retainer clips 316 include an angled head with a lip. As the connector insert 104 is inserted into the slot 210, the complaint arms of the compliant retainer clips 316 deflect until the lip of the compliant retainer clip 316 has passed through the respective accepting hole 214. Once the lip has passed through the respective accepting hole 214, the compliant retainer clip 316 returns to an original position with securement provided by the interaction of the lip of the compliant retainer clip 316 and the surface of the respective accepting hole 214.

In an example, the compliant retainer clips 316 are grouped into pairs with different pairs positioned on opposite and orthogonal sides of the surface of the substrate through which the set of electrical pins 108 extend. For example, a first pair of compliant retainer clips 316-1 and 316-3 may be disposed on opposite sides of a surface of the substrate of the connector insert 104 through which the set of electrical pins 108 extend, and a second pair of compliant retainer clips 316-2 and 316-4 are on the same surface, are also disposed on opposite sides of the same surface, but are orthogonal to the first pair of compliant retainer clips 316-1 and 316-3. As described below in connection with FIGS. 4A-4C, each pair aligns and centers the connector insert 104 within the slot 210 in one direction. For example, the first pair of compliant retainer clips 316-1 and 316-3 center the connector insert 104 in a first direction (e.g., an x-direction), while a second pair of compliant retainer clips 316-2 and 316-4 center the connector insert 104 in a second direction (e.g., a y-direction).

FIGS. 4A-4C illustrate planar views of the connector insert 104 and bay 106 of an example electronic system 100. Specifically, FIG. 4A depicts the connector insert 104 with the electrical pins 108 and compliant retainer clips 316. As described above, functional errors and/or inoperability may arise when the electrical pins 108 of a connector are not correctly aligned with the bay 106. For example, electrical pins misaligned in an x-direction may not mate with electrical connections on the wire harness.

In some examples, the allowed variation in position to ensure proper functionality may be quite small. As such, the present electronic system 100 aligns the connector insert 104 with the respective bay 106. In some examples, this may be performed by aligning the datums, or reference axes, of the respective components. In general, a datum of a component refers to a reference axis by which the position of features of the component is defined. For example, the position of electrical pins 108 of the connector insert 104 may be defined by a position relative to insert datum axes. Similarly, the dimensions of a bay 106 may be defined by a position relative to bay datum axes. Accordingly, when the datums of the connector insert 104 are aligned with the datums of the bay 106, an engineer may place the respective features (e.g., pins 108, guiding structures, ribs, etc.) relative to the datums and have confidence that these features will align with features of the other component. For example, an engineer may define the position of the electrical pins 108 of the connector insert 104 relative to a first insert datum 418-1 and second insert datum 418-2. Given the interaction of the insert alignment structure (e.g., the compliant retainer clips 316) and the housing alignment structure (e.g., the accepting holes 214) of the present electronic system, the engineer may be assured that the first insert datum 418-1 is aligned with the first bay datum 420-1 and that the second insert datum 418-2 is aligned with the second bay datum 420-2, such that the electrical pins 108 of the connector insert 104 are at a precise x- and y-position relative to the bay 106 datums.

In the example depicted in FIG. 4A, the connector insert 104 includes 1) a first insert datum 418-1 defined by a centerline between the first pair of compliant retainer clips 316-1 and 316-3 and 2) a second insert datum 418-2 defined by a centerline between the second pair of compliant retainer clips 316-2 and 316-4.

As depicted in FIG. 4B, the bay 106 includes a first bay datum 420-1 defined by a centerline between accepting holes 214-1 and 214-3 associated with the first pair of compliant retainer clips 316-1 and 316-3 and 2) a second bay datum 420-2 defined by a centerline between accepting holes 214-2 and 214-4 associated with the second pair of compliant retainer clips 316-2 and 316-4.

As depicted in FIG. 4C, the housing alignment structure (e.g., the accepting holes 214) and the insert alignment structure (e.g., the compliant retainer clips 316) align 1) the first insert datum 418-1 with the first bay datum 420-1 in a first direction and 2) the second insert datum 418-2 with the second bay datum 420-2 in a second direction. Thus, the housing alignment structure and the insert alignment structure align the connector insert 104 within the slot 210 in two orthogonal directions in a two-dimensional plane. In the reference plane of FIGS. 4A-4C, the connector insert 104 is aligned within the slot in an x-direction and a y-direction with alignment in the z-direction provided by the connector insert 104 interaction with the shelf 212.

Also as depicted in FIG. 4C, the operation of the connection system (i.e., the interaction of the housing alignment structure and the insert housing structure) presses centrally against the connector insert 104 to align the set of electrical pins 108 to the bay 106. That is, the connection system does more than just secure the connector insert 104. For example, a force is applied by the compliant retainer clips 316 towards the central axes of the connector insert 104, as depicted by the arrows in FIG. 4C. As such, the present electronic system 100 includes a connector insert 104. which is inserted into a slot 210 of a housing 102 and centered while being positioned and fixed by a connection system that presses against a center portion of the connector insert 104. As such, the housing alignment structure and the insert alignment structure center the connector insert 104 within the slot 210.

As depicted in FIGS. 4A-4C, the pairs of compliant retainer clips 316 may have different dimensions. Altering the dimensions of the compliant retainer clips 316 may alter the force they exert on the connector insert 104. Accordingly, for portions of the connector insert 104 that are larger (e.g., the top and bottom surfaces respectively of the connector insert 104 when viewed from the perspective of FIGS. 4A-4C), wider and/or thicker compliant retainer clips 316 may be implemented. In some examples, the compliant retainer clips 316 may be sized to exert an equal force on each side of the connector insert 104. In other examples, the compliant retainer clips 316 may be sized to exert different forces on different sides of the connector insert 104.

Moreover, the size and shape of the compliant retainer clips 316 may vary between connector insert 104. That is, each connector insert 104 may have material properties that alter the force to be applied by the retainer clips 316 to ensure alignment within a respective bay 106. For example, a compliant retainer clip 316 with too small a resistance to elastic deformation may break or snap during insertion. By comparison, a compliant retainer clip 316 with too large a resistance to elastic deformation may use a larger insertion force, which may damage the components of the electronic system 100 (i.e., the connector insert 104 and/or the housing 102). Accordingly, the dimensions of the compliant retainer clips 316 and accepting holes 214 may be selected based on any number of criteria such as the geometry of the connector insert 104, a length of the connector insert 104, a width of the connector insert 104, a thickness of the connector insert 104, a weight of the connector insert 104, a quantity of electrical pins 108, a dimension of the electrical pins 108, a weight of the electrical pins 108, and material properties (e.g., elastic deformation, thermal expansion, thermal contraction, material thickness, and dimensional variability, among others) of the connector insert 104.

FIG. 5A illustrates a cross-sectional view of the connector insert 104 and bay 106 of an example electronic system 100. Specifically, FIG. 5A is a cross-sectional view taken along the line 5-5 from FIG. 4C. FIG. 5A depicts various components described above, such as the bay 106, which guides the insertion of the wire harness and mechanically protects the electrical pins 108 of the connector insert 104 and guides a wire harness to couple with the electrical pins 108. FIG. 5A also depicts a pair of the compliant retainer clips 316-1 and 316-3, which slide and snap into the accepting holes 214 of the housing 102. In particular, as described above, the compliant retainer clips 316 include angled heads, which cause the arms of the retainer clips 316 to deflect inward as they are inserted into the accepting holes 214. Once the angled head passes through the accepting hole 214, the arms return to an orientation depicted in FIG. 5A, with the lip of the angled head resting against the shelf 212 of the housing 102. As described above, the compliant retainer clips 316 may press against the walls of the accepting holes 214 in a fashion that generates an inward force on the connector insert 104, as depicted in FIG. 5A. For example, the arms of the compliant retainer clips 316 may be biased outward away from the connector insert 104 body. This outwardly directed force is impeded by an outside wall of the respective accepting hole 214, so the force is directed inward. As such, the connector insert 104 and bay 106 datums are aligned via this force. Similarly, the other pair of compliant retainer clips 316-2 and 316-4 align the connector insert 104 and bay 106 datums that are orthogonal to those depicted in FIG. 5A.

FIG. 5B illustrates a cross-sectional view of the connector insert 104 and bay 106 of an example electronic system 100. In the example depicted in FIG. 5B, the compliant retainer clips 316 are instead formed on the housing within the bay 106 and are received into accepting holes 214 on the connector insert 104. That is, FIG. 5B depicts an inverse alignment system from that depicted in FIG. 5A. Specifically, the complaint retainer clips 316 formed on the housing include an arm extending perpendicular from an interior sidewall of the bay 106. A compliant arm extends parallel to the interior sidewall. In this example, the insert alignment structure includes accepting holes 214 that correspond to and receive the set of compliant retainer clips 316.

However, the same interaction of the compliant retainer clips 316 and the respective accepting holes 214 as described above, applies in this case as well. Similarly, the other pair of compliant retainer clips 316-2 and 316-4 may also be formed on the housing 102 with associated accepting holes 214 formed on the connector insert.

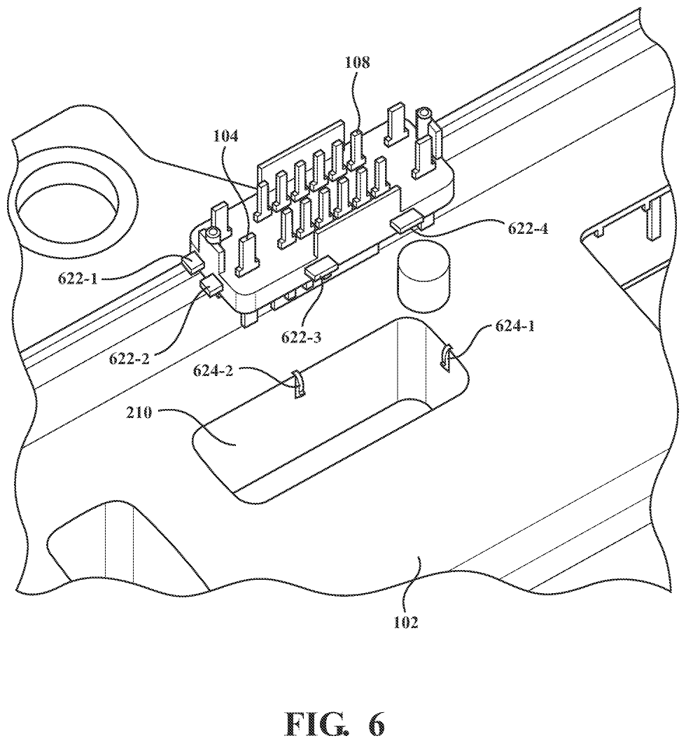

FIG. 6 illustrates an exploded view of an electronic system 100 with an aligned connector insert 104 and housing 102. In this example, the insert alignment structure includes a first set of datum pads 622-1 and 622-2 extending from the first sidewall of the substrate and a second set of datum pads 622-3 and 622-4 extending from a third sidewall of the substrate, which third sidewall is adjacent to and orthogonal to the first sidewall. The housing alignment structure includes a first spring 624-1 on an interior surface of the slot that is opposite the first sidewall from which the first set of datum pads 622-1 and 622-2 extend. The housing alignment structure also includes a second spring 624-2 on an interior surface of the slot 210 opposite the second sidewall from which the second set of datum pads 622-3 and 622-4 extend. The connector insert 104 is centered and aligned as the springs 624 press datum pads 622 on opposing walls against the sidewalls of the slot 210. That is, the datum pads 622 may be sized such that when firmly pressed against a respective sidewall of the slot 210, the datums of the connector insert 104 and the bay 106 are aligned as depicted in FIG. 7C. The spring force of the springs 624 aligns the connector insert 104 and generates a friction force between the datum pads 622 and interior sidewalls of the slot 210 that secure the connector insert 104 in place.

FIGS. 7A-7C illustrate planar views of the connector insert 104 and bay 106 of an example electronic system 100. Specifically, FIGS. 7A and 7B depict the connector insert 104 with the electrical pins 108 and connection system that includes datum pads 622-1, 622-2, 622-3, and 622-4 that are disposed on adjacent and orthogonal side surfaces of the substrate and springs 624-1 and 624-2 that are disposed on adjacent and orthogonal interior sidewalls of the slot 210 of the housing 102. As described above, functional errors and/or inoperability may arise when the electrical pins 108 of a connector are not correctly aligned with the bay 106. To address this issue, the present electronic system 100 ensures that the datums, or reference axes, of the connector insert 104 and bay 106 are aligned with one another. Accordingly, when the datums of the connector insert 104 are aligned with the datums of the bay 106, an engineer may place the respective features (e.g., pins 108, guiding structures, ribs, etc.) of either component relative to the component datums and have confidence that these features will align with features of the other component. For example, an engineer may define the position of the electrical pins 108 of the connector insert 104 relative to a first insert datum 726-1 and second insert datum 726-2. Given the interaction of the insert alignment structure (e.g., the datum pads 622) and the housing alignment structure (e.g., the springs 624) in the present electronic system 100, the engineer may be assured that the first insert datum 726-1 is aligned with the first bay datum 728-1 and that the second insert datum 726-2 is aligned with the second bay datum 728-2, such that the electrical pins 108 of the connector insert 104 are at a precise x- and y-position relative to the bay 106.

In the example depicted in FIG. 7A, the connector insert 104 includes 1) a first insert datum 726-1 defined by a centerline between the first pair of datum pads 622-1 and 622-2 and 2) a second insert datum 726-2 defined by a centerline between a second pair of datum pads 622-3 and 622-4. The alignment of these datums with corresponding bay datums 728-1 and 728-2 allows the component features (e.g., pins) to be aligned relative to features found on the other component. For example, were the electrical pins 108 to be misaligned with the bay 106, a user may not be able to insert a wire harness due to interference of the electrical pins 108 with the electrical terminals of the wire harness. As such, by aligning the insert and bay datums, features that have a predetermined positional relationship to the datums can be aligned with features on the other component.

As depicted in FIG. 7B, the bay 106 includes a first bay datum 728-1 defined by a first spring 624-1 associated with the first pair of datum pads 622-1 and 622-2 and 2) a second bay datum 728-2 defined by a second spring 624-2 associated with a second pair of datum pads 622-3 and 622-4.

To ensure proper seating of the datum pads 622, the slot 210 of the housing 102 may include datum grooves 730-1, 730-2, 730-3, and 730-4 that receive and prohibit translational movement of the respective datum pads 622.

As depicted in FIG. 7C, the housing alignment structure (e.g., the springs 624) and the insert alignment structure (e.g., datum pads 622) align 1) the first insert datum 726-1 with the first bay datum 728-1 in a first direction and 2) the second insert datum 726-2 with the second bay datum 728-2 in a second direction. Thus, the housing alignment structure and the insert alignment structure align the connector insert 104 within the slot 210 in two orthogonal directions in a two-dimensional plane. In the reference plane of FIGS. 7A-7C, the connector insert 104 is aligned within the slot 210 in an x-direction and a y-direction.

As depicted in FIG. 7C, the operation of the connection system (i.e., the interaction of the housing alignment structure and the insert housing structure) presses centrally against the connector insert 104 to align the set of electrical pins 108 to the bay 106. That is, the connection system does more than just secure the connector insert 104. For example, a force is applied by the springs 624 towards the central axes of the connector insert 104, as depicted by the arrows in FIG. 7C. As such, the present electronic system 100 includes a connector insert 104, which is inserted into a slot 210 of a housing 102 and centered while being positioned and fixed by a connection system that presses against a center portion of the connector insert 104. As such, the housing alignment structure and the insert alignment structure center the connector insert 104 within the slot 210.

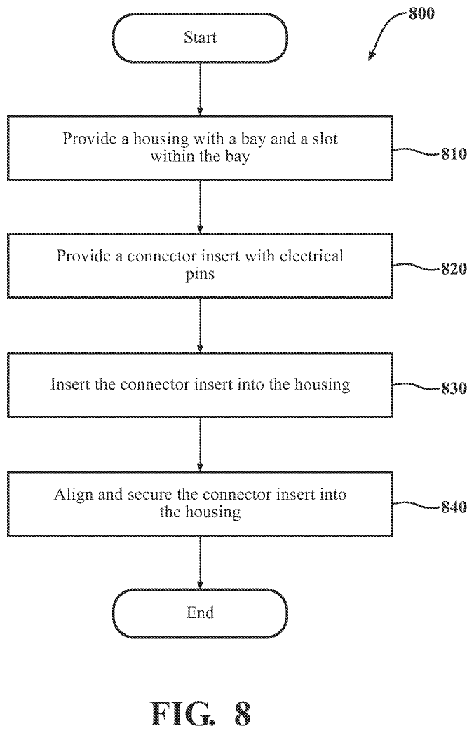

FIG. 8 illustrates a flowchart for one embodiment of a method 800 that is associated with forming an electronic system 100 with a connector insert 104 and a housing 102. At 810, the method 800 includes providing a housing 102 that includes a bay 106 to receive a wire harness and a slot 210 within the bay 106 to receive a connector insert 104. That is, as described above, a connector insert 104, which includes electrical pins 108 for establishing an electrical connection between electrical components such as a wire harness and PCB, is configured to be positioned in a slot 210 of a housing 102. At 820, the method 800 includes providing the connector insert 104, which includes the electrical pins 108 extending through the opposite surfaces of the substrate, as depicted in FIGS. 5A and 5B.

At 830, the connector insert 104 is inserted into the housing 102. In an example, the connector insert 104 is inserted into the housing 102 from a side opposite the surface of the housing 102 from which the bay 106 extends. For example, if the bay 106 is defined as extending from an outside surface of the housing 102, the connector insert 104 is inserted into the slot 210 from the inside surface of the housing 102.

As described above, each component (i.e., the connector insert 104 and the housing 102) includes alignment structures that secure and align the connector insert 104 relative to the bay 106 of the housing 102. Regardless of the form of the alignment structures at 840, the connector insert 104 is aligned and secured within the housing 102 via the interaction of the insert alignment structure and the housing alignment structure.

In the example where the insert alignment structure includes a set of compliant retainer clips 316 protruding from at least one of the opposite surfaces of the substrate of the connector insert 104 and the housing alignment structure includes a set of accepting holes 214 that receive the set of compliant retainer clips 316 as depicted in FIGS. 3-5A, securing the connector insert 104 within the slot 210 includes snapping the compliant retainer clips 316 into respective accepting holes 214.

In the example where the housing alignment structure includes a set of compliant retainer clips 316 and the insert alignment structure includes a set of accepting holes 214 that receive the set of compliant retainer clips 316 as depicted in FIG. 5B, securing the connector insert 104 within the slot 210 includes snapping the compliant retainer clips 316 into respective accepting holes 214.

In the example where the insert alignment structure includes datum pads 622 and the housing alignment structure includes springs 624, securing the connector insert 104 within the slot 210 includes exerting, via the springs 624, a force against the sidewalls of the connector insert 104 that are opposite the sidewalls that include the datum pads 622.

In either example, securing the connector insert 104 within the slot 210 via an insert alignment structure and a housing alignment structure, the housing alignment structure centrally pressing against the connector insert 104 to align the set of electrical pins 108 to the bay 106. Note that in some examples, a housing 102 may retain multiple connector inserts 104 as depicted in FIG. 1. In this example, different connector inserts 104 may utilize different connection systems to secure respective connector inserts 104 into respective bays 106. Such a determination may be based on any number of criteria. As such, the present electronic system 100 provides for the alignment of different connector inserts 104 on a per-insert basis rather than attempting to align different connector pin sets that are directly coupled to one another via attachment to a single PCB. That is, as described above, if multiple connector pins sets are attached to a single PCB, it may be difficult to ensure alignment of the multiple connector pin sets as they are incapable of independent movement and alignment. That is, movements to align one pin set may trigger misalignment of the other pin sets. As such, by individually aligning connector inserts 104 and aligning the respective reference datums with the datums of a bay 106 into which the connector insert 104 is inserted, the present electronic system 100 ensures functional operation by ensuring that functional components of the connectors are aligned within a bay 106 and can properly receive wire harnesses and couple such to the electrical pins 108 of a connector and the associated electronic module.

Detailed embodiments are disclosed herein. However, it is to be understood that the disclosed embodiments are intended as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-8, but the embodiments are not limited to the illustrated structure or application.

The flowcharts and block diagrams in the figures illustrate the architecture, functionality, and operation of possible implementations of systems and methods according to various embodiments. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or attributes thereof. Accordingly, reference should be made to the following claims, rather than to the foregoing specification, as indicating the scope hereof.

What is claimed is:

1. An electronic system, comprising:
a connector insert, comprising:
a set of electrical pins extending through a substrate; and
an insert alignment structure extending from a surface of the substrate; and
a housing comprising:
a bay to receive a wire harness;
a slot within the bay to receive the connector insert; and
a housing alignment structure adjacent to the slot, the housing alignment structure:
interfaces with the insert alignment structure to secure the connector insert; and
presses centrally against the connector insert to align the set of electrical pins to the bay.

2. The electronic system of claim 1, wherein the housing alignment structure and the insert alignment structure center the connector insert within the slot.

3. The electronic system of claim 1, wherein the housing alignment structure and the insert alignment structure align the connector insert within the slot in two orthogonal directions in a two-dimensional plane.

4. The electronic system of claim 1, wherein:
the insert alignment structure comprises a set of compliant retainer clips, the set of compliant retainer clips protruding from a surface of the substrate through which the set of electrical pins extends; and
the housing alignment structure comprises a set of accepting holes that correspond to and receive the set of compliant retainer clips.

5. The electronic system of claim 4, wherein the set of compliant retainer clips comprises:
a first pair of compliant retainer clips disposed on opposite sides of the surface; and
a second pair of compliant retainer clips orthogonal to the first pair and disposed on opposite sides of the surface.

6. The electronic system of claim 5, wherein:
the connector insert further comprises a first insert datum defined by a centerline between the first pair of compliant retainer clips and a second insert datum defined by a centerline between the second pair of compliant retainer clips; and
the bay further comprises a first bay datum defined by a centerline between accepting holes associated with the first pair of compliant retainer clips and a second bay datum defined by a centerline between accepting holes associated with the second pair of compliant retainer clips; and
the compliant retainer clips and the accepting holes align:
the first insert datum with the first bay datum in a first direction; and
the second insert datum with the second bay datum in a second direction.

7. The electronic system of claim 4, wherein the compliant retainer clips protrude from the surface of the substrate that faces a surface of the housing from which the bay extends.

8. The electronic system of claim 1, wherein:
the housing alignment structure comprises a set of compliant retainer clips comprising an arm extending from an interior sidewall of the bay and a compliant arm extending parallel to the interior sidewall; and
the insert alignment structure comprises a set of accepting holes that correspond to and receive the set of compliant retainer clips.

9. The electronic system of claim 1, wherein:
the insert alignment structure comprises a first set of datum pads extending from a first sidewall of the substrate; and
the housing alignment structure comprises a first spring on an interior surface of the slot, the first spring applies a force against at least a second sidewall of the substrate that is opposite the first sidewall.

10. The electronic system of claim 9, wherein:
the insert alignment structure comprises a second set of datum pads extending from a third sidewall of the substrate, the third sidewall being adjacent and orthogonal to the first sidewall; and
the housing alignment structure comprises a second spring on the interior surface of the slot, the second spring applies a force against a least a fourth sidewall of the substrate that is opposite the third sidewall.

11. The electronic system of claim 10, wherein the slot further comprises a set of datum grooves corresponding to the set of datum pads, the set of datum grooves and the set of datum pads position the connector insert in the slot.

12. An electronic system, comprising:
a connector insert comprising a set of electrical pins extending through a substrate;
a housing comprising:
a bay to receive a wire harness; and
a slot within the bay to receive the connector insert; and
a connection system comprising:
an insert alignment structure extending from a surface of the substrate; and
a housing alignment structure adjacent to the slot configured to interface with the insert alignment structure, secure the connector insert, and press centrally against the connector insert to align the set of electrical pins to the bay.

13. The electronic system of claim 12, wherein:
the housing alignment structure and the insert alignment structure align:
a first insert datum with a first bay datum in a first direction; and
a second insert datum with a second bay datum in a second direction.

14. The electronic system of claim 12, wherein:
the insert alignment structure comprises:
a first pair of compliant retainer clips disposed on opposite sides of the surface of the substrate through which the set of electrical pins extends; and
a second pair of compliant retainer clips orthogonal to the first pair and disposed on opposite sides of the surface; and
the housing alignment structure comprises a set of accepting holes that correspond to and receive the first pair of compliant retainer clips and the second pair of compliant retainer clips.

15. The electronic system of claim 12, wherein:
the insert alignment structure comprises:
a first set of datum pads extending from a first sidewall of the substrate; and
a second set of datum pads extending from a third sidewall of the substrate, the third sidewall being adjacent and orthogonal to the first sidewall; and
the housing alignment structure comprises:
a first spring on an interior surface of the slot, the first spring applies a force against at least a second sidewall of the substrate that is opposite the first sidewall; and
a second spring on the interior surface of the slot, the second spring applies a force against a least a fourth sidewall of the substrate that is opposite the third sidewall.

16. A method, comprising:
providing a housing comprising:
a bay to receive a wire harness; and
a slot within the bay to receive a connector insert;
providing the connector insert comprising a set of electrical pins extending through opposite surfaces of a substrate; and
securing the connector insert within the slot via an insert alignment structure and a housing alignment structure, the housing alignment structure centrally pressing against the connector insert to align the set of electrical pins to the bay.

17. The method of claim 16, wherein securing the connector insert within the slot via the insert alignment structure and the housing alignment structure, comprises:
aligning a first insert datum with a bay datum in a first direction; and
aligning a second insert datum with a second bay datum in a second direction.

18. The method of claim 16, wherein:
the insert alignment structure comprises a set of compliant retainer clips protruding from at least one of the opposite surfaces;
the housing alignment structure comprises a set of accepting holes configured to receive the set of compliant retainer clips; and
securing the connector insert within the slot comprises snapping the compliant retainer clips into respective accepting holes.

19. The method of claim 16, wherein:
the insert alignment structure comprises a first set of datum pads extending from a first sidewall of the substrate;
the housing alignment structure comprises a first spring on an interior surface of the slot; and
securing the connector insert within the slot comprises exerting, via the first spring, a force against a second sidewall of the substrate that is opposite the first sidewall to align the set of electrical pins to the bay.

20. The method of claim 16, further comprising inserting the connector insert through an opposite surface of the housing from which the bay extends.
